(19) United States
(12) Patent Application Publication
(10) Pub. No.: US 2022/0123646 A1
(43) Pub. Date: Apr. 21, 2022

(54) ROTOR, MACHINE AND METHOD FOR MAGNETIZATION

(71) Applicant: Rolls-Royce Deutschland Ltd & Co KG, Blankenfelde-Mahlow (DE)

(72) Inventors: Tabea Arndt, Erlangen (DE); Peter Kummeth, Herzogenaurach (DE)

(21) Appl. No.: 17/288,749

(22) PCT Filed: Oct. 28, 2019
(86) PCT No.: PCT/EP2019/079391

§ 371 Date: Apr. 26, 2021

(30) Foreign Application Priority Data
Oct. 29, 2018 (DE) 10 2018 218 473.9

(51) Int. Cl. H02K 55/02

(52) U.S. Cl. CPC H02K 55/02

(57) ABSTRACT

The disclosure relates to a rotor for an electrical machine, having a central rotor axis. The rotor includes a rotor carrier and at least one superconducting permanent magnet carried mechanically by the rotor carrier. The rotor further includes a magnetization device having at least one superconducting coil element which surrounds the superconducting permanent magnet and which is suitable for magnetization of the superconducting permanent magnet. Furthermore, an electrical machine including such a rotor and a method for magnetization of at least one superconducting permanent magnet of such a rotor are disclosed.

The present patent document is a § 371 nationalization of PCT Application Serial No. PCT/EP2019/079391, filed Oct. 28, 2019, designating the United States, which is hereby incorporated by reference, and this patent document also claims the benefit of German Patent Application No. 10 2018 218 473.9, filed Oct. 29, 2018, which is also hereby incorporated by reference.

### TECHNICAL FIELD

The present disclosure relates to a rotor for an electrical machine with a central rotor axis, including a rotor support and at least one superconducting permanent magnet which is mechanically supported by the rotor support. The disclosure furthermore relates to an electrical machine having such a rotor and to a method for magnetizing at least one superconducting permanent magnet of such a rotor.

### BACKGROUND

The prior art discloses electrical machines having a stator and a rotor and in which the rotor is configured to generate an electromagnetic excitation field. Such an excitation field may be generated either by permanent magnets which are arranged on the rotor or by coil elements which are arranged on the rotor. Rotors with superconducting coil elements are sometimes used for electrical machines with particularly high power densities. Another possible way of achieving particularly high power densities is the use of superconducting permanent magnets.

The power density of an electrical machine scales with the magnetic flux density that may be generated by the electromagnets or permanent magnets used in the electrical machine. This relationship allows a significant increase in the power density without a significant change in the topology of the electrical machine if, for example, conventional permanent magnets are replaced by superconducting permanent magnets, because higher magnetic flux densities may be generated with these.

One approach to increasing the power density is therefore to equip an electrical machine with permanent magnets composed of superconducting materials. At correspondingly low temperatures, materials of this kind may generate magnetic flux densities in orders of magnitude that are a multiple of the flux densities that may be generated with conventional permanent magnets. For example, it is possible to use a magnet composed of YBCO (yttrium-barium-copper oxide) at approx. 30 K to generate a magnetic field with a magnetic flux density of up to 8 T, while a conventional magnet, (e.g., including NeFeB), generates flux densities in orders of magnitude of approx. 1.2 T.

German Patent Publication No. 10 2016 205 216 A1 describes an electrical machine having superconducting permanent magnets and also a method for magnetizing the permanent magnets. Superconducting permanent magnets are magnetized prior to operation and then permanently maintained at a cryogenic temperature below their critical temperature. A permanent magnetization state is achieved owing to the loss-free flow of current in the superconductor material.

The method described in German Patent Publication No. 10 2016 205 216 A1 for magnetizing the permanent magnets is comparatively complex, because the rotor and the stator of the machine are separated from one another for this purpose and one of these two components of the machine is temporarily replaced by a special magnetization unit. For this purpose, the machine is configured that the rotor and the stator may easily be separated from one another, which increases the outlay in terms of construction for the electrical machine. The separate magnetization unit also results in an additional outlay in terms of apparatus because a further unit is provided in addition to the components of the machine in order to allow the permanent magnets to be magnetized.

### SUMMARY AND DESCRIPTION

Accordingly, an object of the present disclosure is to provide a rotor which overcomes the disadvantage which has been mentioned. In particular, a rotor is to be provided which allows comparatively simple magnetization of a superconducting permanent magnet arranged therein. A further object is to specify an electrical machine having such a rotor. In addition, a method for magnetizing at least one superconducting permanent magnet of such a rotor is to be specified.

These objects are achieved by the rotor, the electrical machine, and the method described herein. The scope of the present disclosure is defined solely by the appended claims and is not affected to any degree by the statements within this summary. The present embodiments may obviate one or more of the drawbacks or limitations in the related art.

The rotor is configured as a rotor for an electrical machine. It has a central rotor axis A. The rotor includes a rotor support and a superconducting permanent magnet which is mechanically supported by the rotor support. The rotor further includes a magnetization apparatus having at least one superconducting coil element which surrounds the superconducting permanent magnet, and which is suitable for magnetizing the superconducting permanent magnet.

In the present context, a superconducting permanent magnet refers to a component which includes a superconductor material and which may be brought into a permanently magnetized state by being magnetized and subsequently maintained at a cryogenic temperature. The described rotor may include a plurality of such superconducting permanent magnets in order to be able to generate a multi-pole magnetic field. These permanent magnets may be distributed over the circumference of the rotor such that (either individually or in groups) they correspond to the individual magnetic poles of a permanently magnetic rotor.

These superconducting permanent magnets (either individually or in groups) are then surrounded by at least one associated superconducting coil element. A plurality of such superconducting coil elements may also be associated with a permanent magnet or a group of permanent magnets. The permanent magnets associated with a particular coil element are thereby surrounded by the respective coil element. In other words, the coil element extends in one or more windings around the associated permanent magnet or the associated group of permanent magnets.

The magnetization of the superconducting permanent magnet by the associated superconducting coil element is achieved by feeding a current into the superconducting coil element. The flow of current in the coil element generates a magnetic field, which imprints a magnetic flux within the superconducting permanent magnet. In order to permanently freeze this magnetic flux in the permanent magnet, the superconducting permanent magnet is advantageously cooled to an operating temperature below the critical temperature of the superconducting material in question. This cooling may in principle take place either before the feeding in, during the feeding in or also after the feeding in.

The use of a superconducting coil element to generate the magnetic field for magnetization advantageously allows comparatively high magnetic fluxes to be generated. Although the rotor is provided with an additional superconducting element for this purpose, the additional outlay in terms of apparatus may be limited by using a cooling device that is already present for cooling the permanent magnet also to cool the superconducting coil element. In order on the one hand to make particularly good use of this effect and on the other hand to achieve effective magnetization, the superconducting coil element may be guided comparatively tightly around the permanent magnet.

The disclosure is thus based on the finding that it may in some circumstances be less expensive in terms of apparatus to provide an additional coil element for the magnetization “in situ” in the rotor than to perform the magnetization by a separate external magnetization device. By using a superconducting coil element for the magnetization, high magnetic fluxes may be generated even with comparatively small conductor cross sections and a correspondingly lower additional mass in the rotor.

The electrical machine has a rotor and a stator arranged in a fixed manner. The advantages of the machine are obtained in a manner similar to the advantages of the rotor which have been described.

The method serves to magnetize at least one superconducting permanent magnet of a rotor. The method includes the following acts: a) cooling the magnetization apparatus of the rotor to an operating temperature below the critical temperature of the superconducting material of the at least one superconducting coil device; b) connecting the magnetization apparatus to an external current source in a stationary state of the rotor; c) feeding a magnetization current into the at least one superconducting coil element of the magnetization apparatus, whereby a magnetic flux is formed in the at least one superconducting permanent magnet; and d) disconnecting the magnetization apparatus from the external current source.

In other words, the superconducting coil device in its superconducting state is here used to be temporarily energized while the rotor is stationary and thus to imprint a magnetization into the permanent magnet. Connection of the superconducting coil device to the external current circuit is required only temporarily and only while the rotor is stationary. In particular, it is no longer necessary for the magnetization apparatus to be connected to the external current circuit when the rotor is operating, or when the electrical machine containing the rotor is operating. The outlay in terms of apparatus for a contacting apparatus for the magnetization apparatus is thereby reduced significantly, because electrical contacting between a stationary system and a rotating system is not required. As a result of this finding, the outlay in terms of apparatus may be reduced significantly compared to a coil that is also to be energized while the rotor is rotating. Otherwise, the further advantages of the method are obtained in a manner similar to the advantages of the rotor and of the machine which have been described. The rotor mentioned for carrying out the method may be, in particular, a rotor in an electrical machine.

The mentioned acts of the method may be carried out, in particular, in the specified order. However, this particular order is not required. It is, however, advantageous in any case if act a) is carried out before act c), so that the coil element is already superconducting during the feeding in of the magnetization current. Furthermore, it may be advantageous if act c) is carried out after act b) or at least is started by act b), because the feeding in of the current is possible only as a result of the connection to an external current source. Similarly, it is advantageous if act d) is carried out after act c) or at least at the end of act c), because disconnection from the external current source interrupts the feeding in. By contrast, the order of acts a) and b) may in principle be chosen arbitrarily.

At least acts b), c), and d) advantageously take place while the rotor is stationary. During act a), on the other hand, the rotor may be in a rotating state or a stationary state. Such rotation may also be started (optionally resumed) on completion of act d), and the electrical machine may thereafter take up its normal operating mode with the now permanently magnetized superconducting permanent magnet. The magnetic flux is then permanently imprinted in the superconducting permanent magnet and is available at least for a certain time of operation of the electrical machine, even without acts b), c), and d) having to be carried out again. If, however, the magnetization has diminished after a certain time of operation or has even broken down completely as a result of warming of the superconducting permanent magnet above the critical temperature, the described acts b), c), and d) may be carried out again. By contrast, cooling again according to act a) is necessary only if the superconducting coil device has in the meantime been warmed beyond its critical temperature.

Here, the embodiments of the rotor, of the machine, and of the method described herein may be combined to advantage.

The at least one superconducting permanent magnet may thus advantageously include a stack of superconducting strip conductors or be formed by such a stack. Such a superconducting strip conductor may have a thin superconducting layer on a strip-like support substrate. In this case, further layers may additionally optionally be present in between and/or above or below the layers mentioned. Particularly advantageously, a plurality of such superconducting strip conductors may be stacked one on top of the other in the radial direction (with respect to the rotor axis). However, in principle, the main direction of stacking may also be oriented differently. In addition, a plurality of individual strip conductors may also be present next to one another in the stack in the circumferential direction and/or in the axial direction. The strip conductors of the entire stack may optionally also be arranged offset in relation to one another between the individual stack layers, wherein, for example, the orientation of the individual strips (that is to say the position of their longitudinal direction) may also change from stack level to stack level. In any case, simple shaping of the superconducting permanent magnet and, in particular, the formation of a desired size is possible in a simple manner due to the formation of strip conductor stacks. Cuboidal permanent magnets may be produced particularly easily in this way.

Alternatively or in addition to the form with one or more strip conductor stacks, the at least one superconducting permanent magnet may also include a superconducting bulk element. In particular, the permanent magnet may be formed by such a bulk element. Here, such a bulk element is a one-piece element composed of superconducting material. Such bulk elements may be produced with any desired geometries. In particular, cuboidal permanent magnets may also be provided relatively easily.

Irrespective of the form and configuration of the at least one superconducting permanent magnet, this may have a high-temperature superconducting material. High-temperature superconductors (HTS) are superconducting materials with a critical temperature above 25 K and in the case of some material classes above 77 K, where the operating temperature may be reached by cooling with other cryogenic materials than liquid helium. HTS materials are also particularly attractive because these materials may have high upper critical magnetic fields and high critical current densities, depending on the choice of operating temperature.

The high-temperature superconductor may include magnesium diboride or a ceramic oxide superconductor, (e.g., a compound of the type REBa2Cu3Ox (abbreviation: REBCO), where RE is a rare-earth element or a mixture of such elements).

According to an advantageous embodiment, the rotor may have a plurality of superconducting permanent magnets. These may be associated, either individually or combined in groups, with individual magnetic poles of the rotor. In particular, they may form the magnetic poles of the rotor. In principle, any shapes are possible for the individual permanent magnets.

When a magnetic pole is formed by a group of a plurality of permanent magnets, then the permanent magnets within a group may be arranged next to one another in the axial direction of the rotor. Alternatively or in addition, the permanent magnets may be arranged next to one another in the azimuthal and/or radial direction of the rotor.

In all these different variants, it may be advantageous if at least one superconducting coil element is associated either with each permanent magnet individually or with each group of associated permanent magnets, so that this coil element surrounds the at least one associated permanent magnet. It is thereby also possible, in principle, that a plurality of surrounding coil elements are also associated with a permanent magnet or with a group of permanent magnets. In any case, it is advantageous in the case of such a plurality of permanent magnets and/or coil elements if there is for each permanent magnet at least one superconducting coil element with which the associated permanent magnet may be magnetized.

According to an advantageous embodiment, the magnetization apparatus may have a plurality of superconducting coil elements, each of which surrounds either a superconducting permanent magnet or a group of superconducting permanent magnets. In other words, each of the coil elements is then provided for the magnetization of at least one permanent magnet associated therewith.

Where a plurality of superconducting coil elements are present in the magnetization apparatus, it may be particularly advantageous if these are electrically connected in series. In this embodiment, simultaneous and uniform energization of all the coil elements of the magnetization apparatus may be achieved in a particularly simple way. In particular, only two current supply lines are then necessary for connecting the magnetization apparatus to an external current source (e.g., arranged outside the rotor). Alternatively or in addition to such a series connection, individual coil elements may also be connected in parallel with one another. In this case too, energization is possible, in principle, with only two external current supply lines, as long as the plurality of coil elements may be arranged electrically within a common current circuit.

In principle, each of the superconducting coil elements may have either one or also a plurality of the windings of the superconducting conductor. It is particularly advantageous in the case of a plurality of coil elements if these are formed with a mutually equal number of windings. In this embodiment, mutually equal magnetization may be generated in the individual superconducting permanent magnets in a particularly simple way via a series connection of the individual coil elements.

Advantageously, the superconducting coil element or the plurality of superconducting coil elements may be so configured that a magnetic flux density of at least 1 T and, in particular, even at least 2 T may thereby be generated within the at least one superconducting permanent magnet. For example, the magnetic flux density generated in the vicinity of a magnetic pole may be in a range of 1 T and 10 T, or in a range of 2 T and 10 T.

According to an advantageous embodiment, the superconducting coil element may have two axially oriented straight coil legs which are arranged azimuthally adjacent to the associated superconducting permanent magnet. This embodiment is particularly advantageous because, in a permanently magnetic rotor, there may be space in the azimuthal direction between the permanent magnets of the individual magnetic poles. This space may thus advantageously be used for the coil legs of the magnetization apparatus. Furthermore, the coil legs in this position do not substantially influence the radial course of the magnetic flux generated by the permanent magnets during operation of the rotor (that is to say after completion of magnetization).

The described “adjacent” arrangement means that the axial coil legs are located azimuthally next to the respective associated permanent magnet. They may be arranged “directly adjacent” thereto in the sense that there is no further electrically active element between the coil leg and the associated permanent magnet. However, other elements located in between are not intended to be ruled out. For example, an additional thermal coupling layer having high thermal conductivity or also a thermal insulation layer having low thermal conductivity may be arranged between the axial coil legs and the associated permanent magnet.

The described straight axial coil legs may be connected to one another in the axial end regions of the rotor by two additional terminal connecting legs to form an annular coil. In these axially terminal positions too, these connecting legs do not substantially influence the radial magnetic flux formed by the permanent magnets. The coil elements may have a rectangular or racetrack-shaped coil cross section, wherein the straight legs of the rectangle or of the racetrack then extend in the axial direction and are located azimuthally next to the associated permanent magnet.

Due to the spatial proximity of the axial coil legs to the associated permanent magnet, strong magnetization may be achieved in a simple way. It may be advantageous for this purpose if the distance between the axial coil legs and the associated permanent magnet is not more than 10 mm. For example, such a distance may advantageously lie in a range of 0.2 mm and 5 mm, or in a range of 1 mm and 5 mm.

Advantageously, the magnetization apparatus of the rotor may have a contacting apparatus for the electrical connection of the at least one superconducting coil element to an external current circuit. Particularly advantageously, this contacting apparatus is suitable for connection to the external current circuit only in a stationary state of the rotor. In the last-mentioned embodiment, the outlay in terms of apparatus for the contacting apparatus may advantageously be kept low. This is based on the finding that magnetization does not have to be carried out while the rotor is rotating but may be carried out in a stationary state of the rotor. The contacting apparatus may have, for example, one or more electrical current supply lines, electrical contact pieces, contact bushings and/or contact plugs. However, it is intended, in particular, not to have a rotary feedthrough or a slip-ring contact. It is thus intended to be a purely stationary contacting apparatus.

According to a first advantageous embodiment variant of the superconducting coil element, this may include a low-temperature superconducting material. In particular, it may be a metallic superconductor, for example, Nb3Sn (with a critical temperature of approx. 18 K) or NbTi (with a critical temperature of approx. 9.2 K). Such low-temperature superconductors are comparatively inexpensive and may be readily available. Therefore, when such materials are used, a magnetization apparatus may be produced with a comparatively low outlay in terms of apparatus. The low operating temperatures required (at least for the phase of magnetization) may nowadays be achieved relatively easily using known cooling apparatuses. Many electrical machines having high-temperature superconductors are nowadays also equipped with cooling apparatuses with which operating temperatures below 20 K and frequently even below 10 K are achievable. This fact may be utilized in the described embodiment variant having a low-temperature superconducting coil device in order to produce, with the existing cooling possibilities, an additional magnetization apparatus which is otherwise of comparatively low complexity. Here, the low-temperature superconductor material of the coil device also does not have to be operated permanently below its critical temperature. Instead, it is sufficient if this is the case in the phase of magnetization of the permanent magnets. This phase may be a very short period of time. A particular advantage of the metallic superconductors is the extremely high current density at these temperatures. For example, it is possible with such materials to achieve current densities above >1000 A/mm² at T=4.2 K and B=5 T.

According to a second alternative embodiment variant, the at least one superconducting coil element may also include a high-temperature superconducting material. Here too, the materials mentioned above in connection with the superconducting permanent magnet may be used as the high-temperature superconducting material for the superconducting coil element. The high-temperature superconducting conductors are many times more expensive than comparable conductors composed of low-temperature superconducting material. However, they may be advantageous in order to be able to achieve high current densities with the coil element and/or in order to be able to operate the superconducting coil element at a similar operating temperature as a high-temperature superconducting permanent magnet arranged within the coil element.

Advantageously, the rotor may have a cooling apparatus which is suitable for cooling both the at least one superconducting permanent magnet and the at least one superconducting coil element to an operating temperature below the critical temperature of the respective superconducting material. Here, the critical temperatures for the permanent magnet and the superconducting coil element may be different if different superconducting materials are chosen therefor. In a normal operating state of the rotor (in particular, during operation of an electrical machine having this rotor), the temperature does not necessarily have to be permanently below the critical temperature of the superconducting coil element. It is sufficient if this is the case in the phase of magnetization.

The cooling apparatus may include at least one cryostat within which there is arranged the rotor support with the at least one permanent magnet and the at least one coil element. For example, a fluid coolant, which cools the rotor support together with the further elements, may be introduced into such a cryostat. The cooling apparatus may include a closed coolant circuit in which such a fluid coolant may circulate. The cryostat may have a vacuum space for better thermal insulation. This vacuum space may be, for example, an annular vacuum space which radially surrounds the rotor support and the at least one permanent magnet arranged thereon. The at least one permanent magnet and the at least one coil element may be thermally coupled to the rotor support, so that they may be cooled together therewith to a cryogenic temperature.

According to a first advantageous embodiment variant of the thermal configuration, the superconducting permanent magnet and the associated superconducting coil element may be thermally coupled such that, in a normal operating state of the cooling apparatus, the permanent magnet and the coil element are together cooled to a cryogenic operating temperature. In other words, the permanent magnet and the associated coil element are to be thermally coupled so closely that their normal operating temperature is similar. For example, their temperature levels in normal operation may then have a difference of not more than 5 K and, in particular, not more than 2 K. In particular, in such normal operation, the temperature is below the critical temperatures both for the superconducting material of the permanent magnet and for the superconducting material of the coil element, so that both elements are superconducting. For example, in this embodiment the permanent magnet and the coil element may together be cooled by joint thermal coupling to the rotor support. In other words, they thus jointly form a superordinate element which is to be cooled. This first embodiment variant may be provided when the superconducting permanent magnet is already to be in the superconducting state during the magnetization (that is to say during the imprinting of the magnetic flux in act c) of the method). In this variant, a higher magnetic field is generated in order to achieve a predefined magnetic flux in the final state. However, on the other hand, joint cooling of permanent magnet and coil element is possible in this variant, and a substantially uniform cooling state may be maintained between the magnetization phase and the normal operating state of the rotor.

According to an alternative, second embodiment variant of the thermal configuration, the rotor may additionally have a heating element in the region of the superconducting permanent magnet. Furthermore, the superconducting permanent magnet and the associated superconducting coil element may be thermally decoupled such that the coil element may be brought into a superconducting state by cooling with the cooling apparatus while the permanent magnet is brought into a warm, normally conducting state by heating with the heating element. The advantage of this embodiment variant is that the magnetic flux enters the comparatively warm (and thus normally conducting) superconductor without difficulty and is anchored by subsequent cooling below the critical temperature. This embodiment may be provided in some circumstances because a lower magnetic field is then required during the magnetization phase for the same final magnetization, because the magnetic flux homogeneously penetrates the normally conducting material of the superconducting permanent magnet and is then locally anchored by subsequent cooling below the critical temperature.

In accordance with the described embodiment variants of the rotor, the two alternative variants for the thermal coupling may also be used in the method.

Thus, according to a first advantageous embodiment of the method, act c) may be carried out in a state of the rotor in which the at least one superconducting permanent magnet has also been cooled to a cryogenic temperature below the critical temperature of its superconducting material. This is advantageously achieved with a first embodiment of the rotor in which the superconducting permanent magnet and the associated superconducting coil element are thermally comparatively closely coupled.

According to an alternative, second embodiment of the method, act c) may be carried out or at least begin in a state of the rotor in which the at least one superconducting permanent magnet is at a temperature above the critical temperature of its superconducting material. This may be achieved by thermal separation of the at least one superconducting permanent magnet and the associated coil element (for example, by a thermal insulation layer located between them). Furthermore, this may be achieved by local heating of the superconducting permanent magnet with a heating element. Such a heating element may be, for example, a heating foil which is arranged on the outside surfaces of the permanent magnet that are not adjacent to the coil element.

When the at least one superconducting permanent magnet is heated locally to a temperature above the critical temperature for the phase of magnetization, the rotor support (and the at least one coil element) may advantageously remain at a lower cryogenic temperature level. This also allows comparatively rapid cooling of the superconducting permanent magnet back to a superconducting state during the magnetization phase.

The following further act may be provided in the method: e) cooling the superconducting permanent magnet to an operating temperature below the critical temperature of the superconducting material of the permanent magnet.

Depending on the chosen variant for the thermal coupling, this additional act e) may be carried out either before the feeding in of the current in act c) (first embodiment) or after or temporally overlapping with the feeding in of the current in act c) (second embodiment).

### BRIEF DESCRIPTION OF THE DRAWINGS

The disclosure will be described below using two exemplary embodiments with reference to the appended drawings, in which:

FIG. 1 depicts a schematic cross section of a first exemplary embodiment of an electrical machine and

FIG. 2 depicts a schematic cross section of a second exemplary embodiment of an electrical machine.

In the figures, elements that are identical or have the same function are provided with the same reference signs.

### DETAILED DESCRIPTION

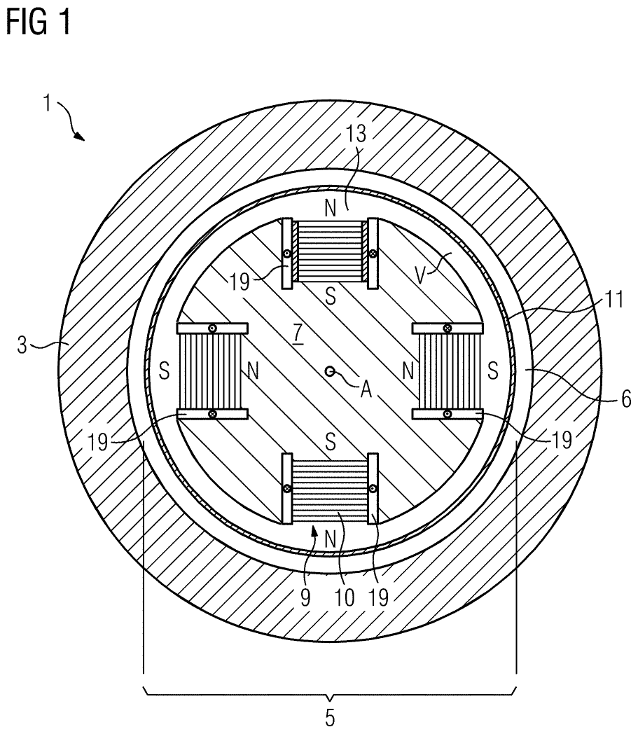

FIG. 1 shows a schematic cross section of an electrical machine 1, that is to say shows the electrical machine perpendicularly to the central axis A. The machine includes an external stator 3, which is arranged in a fixed manner, and an internal rotor 5 which is rotatably mounted about the central axis A. The electromagnetic interaction between the rotor 5 and the stator 3 takes place across the air gap 6 situated between them. The machine is a permanently excited machine which has a plurality of superconducting permanent magnets 9 in order to form an excitation field in the region of the rotor. In the cross section of FIG. 1, here by way of example four permanent magnets of this type are distributed over the circumference of the rotor. They are arranged in corresponding radially outer recesses of a rotor support 7, wherein the rotor support 7 mechanically supports the permanent magnets 9. However, yet further permanent magnets than the four shown here may also be present in the axial direction, not shown here, wherein the number of magnetic poles of the electrical machine is not increased by such an axial subdivision however.

The rotor support 7, together with the permanent magnets 9 held thereon, is cooled by a cooling apparatus to a cryogenic operating temperature, which is below the critical temperature of the superconductor material used in the permanent magnets. In order to maintain this cryogenic temperature, the rotor support 7 and the permanent magnets 9 are arranged in the interior of a cryostat 11 together. There is an annular vacuum space V for thermal insulation between the cryostat and the rotor support 7.

In the exemplary embodiment in FIG. 1, the individual permanent magnets 9 are each in the form of a strip conductor stack composed of individual superconducting strip conductors 10. In this case, a respective plurality of such superconducting strip conductors 10 are stacked one on top of the other in a radial direction.

The four individual permanent magnets 9 are each surrounded by an associated superconducting coil element 19. The permanent magnets 9 are thus each arranged in the center of such a coil element 19. The individual coil elements 19 are here in the form of, for example, rectangular coils. Each of the coil elements 19 has two straight axial coil legs, which in the cross-sectional representation of FIG. 1 are shown azimuthally next to the respective permanent magnets 9 on both sides. In the axial end regions, not shown here, of the rotor, these axial coil legs associated in pairs are in each case closed by terminal connecting legs to form an annular coil. Overall, each of the coil elements 19 is thus positioned in an annular manner around an associated permanent magnet 9, wherein in each case both the radially inner region and the radially outer region of the permanent magnets 9 remain free.

In the example of FIG. 1, the superconducting coil elements 19 are arranged very closely next to the associated permanent magnets 9. In some circumstances, the superconducting coil elements 19 may even be in contact with one another. In the example of FIG. 1, superconducting coil elements 19 are in any case thermally closely coupled with one another, so that they may jointly be cooled to a cryogenic temperature level by the cold rotor support 7. A thermal coupling layer may optionally also be arranged between the permanent magnets 9 and the associated coil element 19, as is shown here by way of example for the permanent magnet shown at the top.

Not only the permanent magnets 9 but also the superconducting coil elements 19 are cooled to a cryogenic temperature below the critical temperature of the respective superconducting material by the cooling apparatus of the rotor.

In order to magnetize the superconducting permanent magnets 9, a magnetization current is fed into the individual associated coil elements 19. A magnetic flux is thereby generated in the inner superconducting permanent magnets 9. This magnetic flux is permanently maintained even after the magnetization current has been switched off, as long as the permanent magnets 9 remain in the superconducting state.

Feeding in of the magnetization current takes place during a magnetization phase in which the rotor is in a stationary state. In this stationary state, the superconducting coil elements 19 may be connected via a contacting apparatus, not shown here, to a superordinate current circuit and, in particular, to a fixed external current source. This current source is thus located outside the rotor 5. The contacting apparatus is not provided for the electrical contacting of the rotating rotor but only for the electrical contacting of the stationary rotor. The coil elements 19 form together a magnetization apparatus of the rotor. In this example, they are electrically connected to one another in series. Thus, during the feeding in, a uniform magnetization current flows into all four coil elements. The number of windings of the individual coil elements is also chosen so as to be mutually equal. As a result, a mutually equal magnetic flux profile is imprinted into the individual permanent magnets 9.

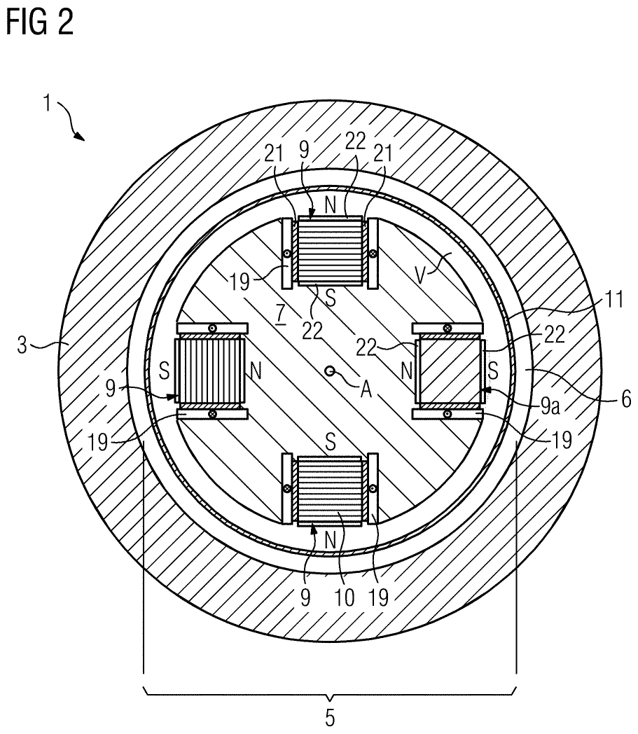

FIG. 2 shows a schematic cross section of an alternative embodiment of an electrical machine 1. This machine is configured similarly to the machine of FIG. 1 in principle. In contrast to FIG. 1, however, the individual permanent magnets 9 are thermally slightly decoupled from the respective associated coil element 19. For this purpose, a thermal insulation layer 21 is in each case arranged between these two elements. This has the effect that, during the magnetization phase, the permanent magnets 9 may be maintained at a slightly higher temperature level, at which the superconducting material present here is maintained above the critical temperature. In order to make such relative warming possible, additional heating elements 22 are arranged in the region of the permanent magnets 9. In the example shown, these heating elements are heating foils which are arranged on the radially inner side and the radially outer side of the respective permanent magnets. These sides are not enclosed by the associated coil elements 19 and are therefore available for local warming.

In order to magnetize the permanent magnets 9 in the example of FIG. 2, the procedure is similar, in principle, to that already described in connection with FIG. 1. However, before the magnetization current is fed in, the permanent magnets 9 are here heated locally by the heating elements 22 to such an extent that they are no longer superconducting. Only after the magnetic flux has been imprinted into the permanent magnets 9 are they also cooled to a cryogenic temperature below the critical temperature of the superconducting material used here.

Merely in order to illustrate that, instead of the superconducting strip conductor stacks, different configurations for the permanent magnets are possible, the permanent magnet shown on the right in FIG. 2 is shown by way of example as a superconducting bulk element 9a. In a real rotor, however, the individual permanent magnets are advantageously of the same form.

In both exemplary embodiments, comparatively simple magnetization of the permanent magnets 9 is thus made possible by the superconducting coil elements 19 arranged in the region of the rotor, wherein the coil elements 19, in a stationary state of the rotor 5, are connected to a fixed external current source. After disconnection from this fixed current source, the rotor may for the first time or again be set into a rotating state. The superconducting permanent magnets 9 thereby remain in a permanently magnetized state, as long as they are maintained below the critical temperature of the superconducting material used here.

Although the disclosure has been illustrated and described more specifically in detail by the exemplary embodiments, the disclosure is not restricted by the disclosed examples and other variations may be derived therefrom by a person skilled in the art without departing from the scope of protection of the disclosure.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

### LIST OF REFERENCE DESIGNATIONS

1 Electrical machine
3 Stator
5 Rotor
6 Air gap
7 Rotor support
9 Superconducting permanent magnet
9a Superconducting bulk element
10 Strip conductor
11 Cryostat wall
13 Thermal coupling layer
19 Superconducting coil element
21 Thermal insulation layer
22 Heating element
A Central rotor axis
N Magnetic north pole
S Magnetic south pole
V Vacuum space

1. A rotor for an electrical machine with a central rotor axis, the rotor comprising:
a rotor support;
at least one superconducting permanent magnet mechanically supported by the rotor support; and
a magnetization apparatus having at least one superconducting coil element surrounding the at least one superconducting permanent magnet and configured to magnetize the at least one superconducting permanent magnet.

2. The rotor of claim 1, wherein the at least one superconducting permanent magnet comprises a stack of superconducting strip conductors, a superconducting bulk element, or a combination thereof.

3. The rotor of claim 1, wherein the at least one superconducting permanent magnet is a plurality of superconducting permanent magnets, and
wherein each superconducting permanent magnet of the plurality of superconducting permanent magnets is associated either individually or combined in groups with individual magnetic poles of the rotor.

4. The rotor of claim 3, wherein the magnetization apparatus has a plurality of superconducting coil elements, and
wherein each superconducting coil element of the plurality of superconducting coil elements encloses either one superconducting permanent magnet or a group of superconducting permanent magnets of the plurality of superconducting permanent magnets.

5. The rotor of claim 1, wherein the at least one superconducting coil element has two axially oriented straight coil legs arranged azimuthally adjacent to the associated superconducting permanent magnet.

6. The rotor of claim 1, wherein the magnetization apparatus has a contacting apparatus for electrically connecting the at least one superconducting coil element to an external current source, and
wherein the contacting apparatus is configured to connect to the external current source only in a stationary state of the rotor.

7. The rotor of claim 1, wherein the at least one superconducting coil element comprises a low-temperature superconducting material.

8. The rotor of claim 1, wherein the at least one superconducting coil element comprises a high-temperature superconducting material.

9. The rotor of claim 1, further comprising:
a cooling apparatus configured to cool both the at least one superconducting permanent magnet and the at least one superconducting coil element to an operating temperature below a critical temperature of a respective superconducting material of the at least one superconducting permanent magnet and the at least one superconducting coil element.

10. The rotor of claim 9, wherein the superconducting permanent magnet and the associated superconducting coil element are thermally coupled such that, in a normal operating state of the cooling apparatus, the superconducting permanent magnet and the superconducting coil element are together cooled to a cryogenic operating temperature.

11. The rotor of claim 9, further comprising:
a heating element in a region of the superconducting permanent magnet,
wherein the superconducting permanent magnet and the associated superconducting coil element are thermally decoupled such that the superconducting coil element is configured to be brought into a superconducting state by cooling with the cooling apparatus, while the superconducting permanent magnet is brought into a warm, normally conducting state by heating with the heating element.

12. An electrical machine comprising:
a stator arranged in a fixed manner, and
a rotor with a central rotor axis, the rotor comprising:
a rotor support,
at least one superconducting permanent magnet mechanically supported by the rotor support; and
a magnetization apparatus having at least one superconducting coil element surrounding the at least one superconducting permanent magnet and configured to magnetize the at least one superconducting permanent magnet.

13. A method for magnetizing at least one superconducting permanent magnet of a rotor, the method comprising:
providing a rotor having a rotor support, at least one superconducting permanent magnet mechanically supported by the rotor support, and a magnetization apparatus having at least one superconducting coil element surrounding the at least one superconducting permanent magnet;
cooling the magnetization apparatus of the rotor to an operating temperature below a critical temperature of a superconducting material of the at least one superconducting coil device;
connecting the magnetization apparatus to an external current source in a stationary state of the rotor;
feeding a magnetization current into the at least one superconducting coil element of the magnetization apparatus, whereby a magnetic flux is formed in the at least one superconducting permanent magnet; and
disconnecting the magnetization apparatus from the external current source.

14. The method of claim 13, wherein the feeding of the magnetization current is carried out in a state of the rotor in which the at least one superconducting permanent magnet has also been cooled to a cryogenic temperature below the critical temperature of a superconducting material of the at least one superconducting permanent magnet.

15. The method of claim 13, wherein the feeding of the magnetization current is carried out in a state of the rotor in which the at least one superconducting permanent magnet is at a temperature above a critical temperature of a superconducting material of the at least one superconducting permanent magnet.

16. The rotor of claim 1, wherein the magnetization apparatus has a plurality of superconducting coil elements, and
wherein each superconducting coil element of the plurality of superconducting coil elements encloses a superconducting permanent magnet of the at least one superconducting permanent magnet.

17. The rotor of claim 6, further comprising:
a cooling apparatus configured to cool both the at least one superconducting permanent magnet and the at least one superconducting coil element to an operating temperature below a critical temperature of a respective superconducting material of the at least one superconducting permanent magnet and the at least one superconducting coil element.

18. The rotor of claim 17, wherein the superconducting permanent magnet and the associated superconducting coil element are thermally coupled such that, in a normal operating state of the cooling apparatus, the superconducting permanent magnet and the superconducting coil element are together cooled to a cryogenic operating temperature.
